(19) United States
(12) Patent Application Publication
(10) Pub. No.: US 2004/0164467 A1
(43) Pub. Date: Aug. 26, 2004

(54) Inflator thermal treatment equipment

(76) Inventors: Keishi Aoyama, Hyogo (JP); Yuji Nakazawa, Hyogo (JP)

Correspondence Address: BIRCH STEWART KOLASCH & BIRCH, PO BOX 747, FALLS CHURCH, VA, 22040-0747, US

(21) Appl. No.: 10/742,871

(22) Filed: Dec. 23, 2003

(30) Foreign Application Priority Data
Dec. 26, 2002 (JP) 2002-376023
Mar. 20, 2003 (JP) 2003-77053

(51) Int. Cl. B60R 21/16

(52) U.S. Cl. 266/251

(57) ABSTRACT

The present invention provides an inflator thermal treatment equipment which can prevent an accidental damage to the equipment. A partition means 25 comprising an iron grating is fixed between a thermally treating tower 10 and an exhaust gas tube 16. When the interior of the thermally treating tower 10 is heated to an ignition temperature of gas generating materials inside inflators 30 or more to burn the gas generating materials, such an event may occur that the inflators 30 jump up due to pressures at combustion. At that time, the inflators 30 jumped up are prevented from colliding against the exhaust gas tube 16 by the partition means 25.

### TECHNICAL FIELD WHERE THE INVENTION BELONGS

The present invention relates to an improved inflator thermal treatment equipment for treating inflators for an air bag at a high temperature.

### PRIOR ART

Recently, since new cars equipped with an air bag(s) has increased, a great deal of inflators accommodating gas generating materials therein will hereafter are seen at a scrapping of these cars equipped with air bags. Therefore, from the viewpoint of safety and effective utilization of resources, it is necessary to ignite the gas generating materials by thermal treatment safely to recover metals and the like therefrom. Under such circumstances, a recovery/treatment system for inflators for an air bag is being started.

For treatment of inflators for an air bag, a method in which thermal treatment is conducted to inflators for an air bag inside a thermally treating tower to ignite and burn gas generating materials accommodated in the inflators by a high temperature treatment. Then, a combustion gas generated from the treatment of the gas generating materials is exhausted from an exhaust gas tube connected to the thermally treating tower.

When the inflators are treated inside the thermally treating tower in this manner, there may occur such an event that an inflator(s) jumps up violently due to action of a pressure generated at a time of combustion of a gas generating material(s). Then, when the magnitude that the inflator(s) jumps up is great, the inflator(s) jumps out of the thermally treating tower to enter an exhaust gas tube and stay therein or to collide against the exhaust gag tube violently, so that the exhaust gas tube may be damaged. When the exhaust gas tube is damaged, such an accident may occur that an exhaust gas leaks out to the outside atmosphere. Further, an inflator(s) jumps into a combustion furnace which feeds a heating gas into the thermally treating tower, so that the combustion furnace may be damaged.

As a conventional technique relating to this invention, JP11-101422A publication is listed.

### DISCLOSURE OF THE INVENTION

In order to solve the above problems, the present invention is to provide an improved inflator thermal treatment equipment.

As a solving means of the above problems, the invention described in claim 1 provides an inflator thermal treatment equipment for treating inflators for an air bag at a high temperature, comprising at least:

a thermally treating tower, and an exhaust gas tube for exhausting a gas generated inside the thermally treating tower, wherein a partition means which allows ventilation is provided between the thermally treating tower and the exhaust gas tube.

By providing the partition means which allows ventilation, when an inflator jumps up using a pressure generated due to combustion of gas generating materials as a propelling force, the inflator is prevented from jumping out of the thermally treating tower and a smooth gas exhausting state can be maintained.

It is preferable that the partition means which allows ventilation allows a gas to pass therethrough but it does not allow the inflator and fragments produced due to break of the inflator to pass therethrough.

Since such a situation is also predicted that, when the inflator jumps up to collide against an inner wall of the thermally treating, an outer shell container (a housing, a shell and the like) of the inflator is broken to become small pieces, it is preferable that the size of holes in the partition means which allows ventilation is set considering the above situation.

As the partition means which allows ventilation, a wire mesh, a punching metal or a grating made of metal can be used, and ones having a strength (a material, a thickness or the like) capable of standing a pressure generated when the inflator or fragments thereof collides against them endured are used.

Two or more partition means which allow ventilation may be disposed to be spaced from each other. In that case, passing-through of the inflator or fragments produced by break of the inflator may be blocked by a combination of two partition means.

Such a combination of two partition means can be obtained by a combination of an annular partition means disposed at the upstream side of an exhaust gas and a flat plate-like partition means disposed at the downstream side of the exhaust gas, or an disposition reversed thereto can be employed. At this time, the flat plate-like partition means disposed at the upstream side or the upstream side has holes with an area larger than that of holes of the annular partition means, and the holes of the flat plate-like partition means are disposed to be exactly opposite to the holes of the annular partition means.

By combining two partition means in this manner, an impact generated when a jumped inflator collides against the partition means can be dispersed to the two partition means, so that a durability can be enhanced as compared with the case of only one partition means. For this reason, a life until replacement of the partition means can be prolonged.

It is preferable that the partition means which allows ventilation is mounted removably inside the exhaust gas tube, inside the thermally treating tower or inside a coupling tube between these members. When the partition means is mounted inside the exhaust gas tube or inside the coupling tube, it is preferable that the partition means is mounted at a position in the vicinity of the thermally treating tower. Further, it is preferable that the partition means is mounted removably at a flange portion provided on an inner wall surface or an outer wall surface of the exhaust gas tube or the coupling tube, or a flange portion provided on an inner wall surface of the thermally treating tower. As a mounting method, a method for conducting fixation using a bolt and a nut or the like can be applied.

By conducting mounting at the flange portion in this manner, a force against a pressure at a time of collision of the inflator or fragments thereof is improved.

The constitution of the inflator thermal treatment equipment of the present invention is not limited particularly, but it is preferable that an inflator charging port and a combustion furnace are attached together with the thermally treating tower, and a means for cooling an exhaust gas is attached at the exhaust gas tube.

It is preferable that a partition means which allows ventilation and that allows passing-through of a gas but prevents the inflator and fragments produced by break of the inflator from passing is mounted removably between the combustion furnace attached to the thermally treating tower and the interior of the thermally treating tower. A portion defined between the combustion furnace and the interior of the thermally treating tower is a heating gas outlet duct of the combustion furnace, or an inner wall surface of the thermally treating tower of a connection portion between the heating gas outlet duct and the thermally treating tower.

By providing the partition means between the combustion furnace and the interior of the thermally treating tower in this manner, too, the inflator or fragments thereof are prevented from jumping into the combustion furnace to stay therein and close a heating gas outlet or damage the combustion furnace itself.

The inflators for an air bag which are the treatment subject in the present invention include all inflators required for treatment from various reasons, for example, failure products produced in a manufacturing process, returned articles from an automobile manufacturer or a module manufacturer, stock products after manufacturing thereof has been stopped, an inflator removed from scrapped vehicles.

According to the inflator thermal treatment equipment of the present invention, since the partition means is provided between the thermally treating tower and the exhaust gas tube, when inflators are heated and treated, an inflator jumped up is prevented from jumping into the exhaust gas tube or damaging the exhaust gas tube.

### BRIEF DESCRIPTION OF THE DRAWINGS

FIG. 1 is a conceptual diagram of an inflator thermal treatment equipment including a thermally treating tower;

FIG. 2 is a schematic partially sectional view of one embodiment of a thermally treating tower;

FIG. 3 is a schematic partially sectional view of another embodiment of a thermally treating tower; and

FIG. 4 is a view for explaining a method for mounting a partition means.

Explanation of Numerals

10 thermally treating tower

12 inflator charging port

14 combustion furnace (burner)

16 exhaust gas tube

18 cooling tower tank

25 partition means

### PREFERRED EMBODIMENTS OF THE INVENTION

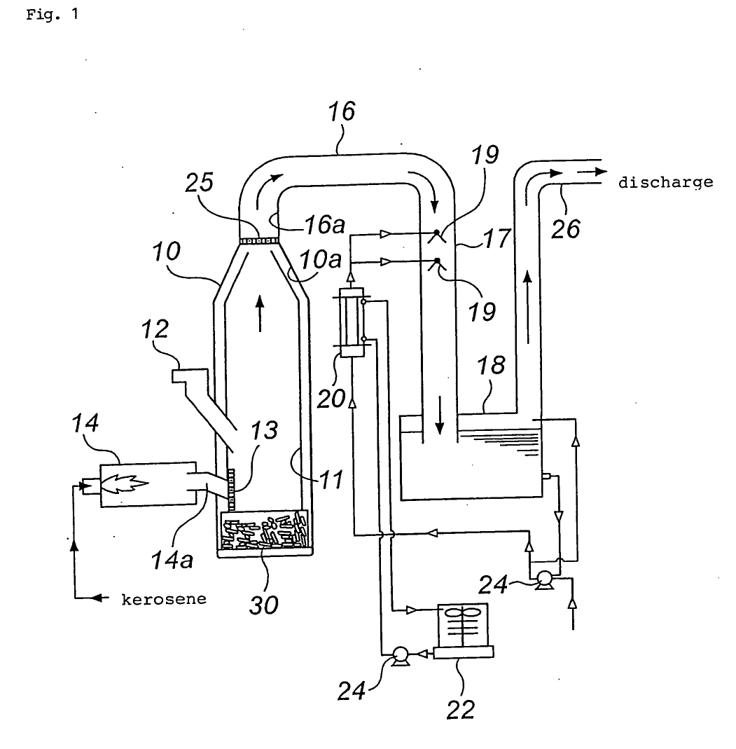

An embodiment of the present invention will be explained below with reference to the drawings. FIG. 1 is a conceptual diagram of an inflator thermal treatment equipment provided with a thermally treating tower.

A thermally treating tower 10 is provided with an inflator charging port 12 for charging inflators 30 which are the treatment subjects and a combustion furnace (a burner) for heating and temperature-raising the interior of the thermally treating tower 10. The combustion furnace (for example, a combination of a high calorie burner and a lower calorie burner) 14 is supplied with kerosene as a fuel.

An exhaust gas tube 16 for exhausting a gas generated inside the thermally treating tower 10 is connected to an upper opening portion of the thermally treating tower 10. A distal end of the exhaust gas tube 16 is connected to a cooling tower tank 18, and after a gas passing through the interior of the exhaust gas tube 16 is absorbed in the water inside the cooling tower tank 18, it is discharged from a gas discharging tube 26 to the atmosphere. The numeral 20 denotes a heat exchanger, the numeral 22 denotes a cooling tower, and the numeral 24 denotes a pump. Incidentally, a metal partition wall 11 functioning in the same manner as one disclosed in FIG. 1 in JP-A 11-101422 or the like can be provided inside the thermally treating tower 10.

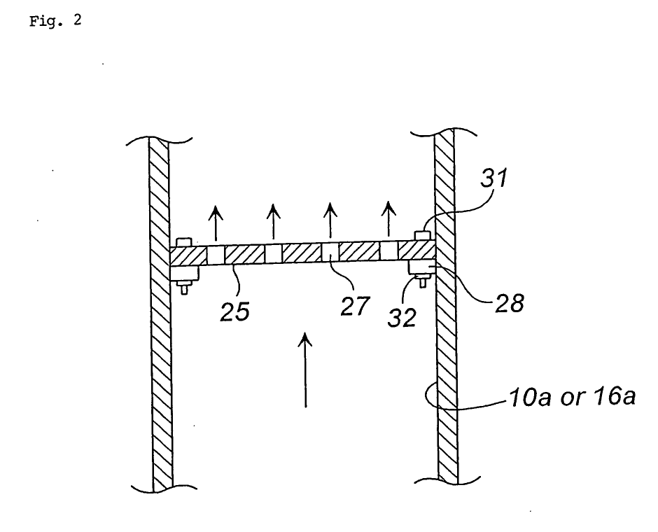

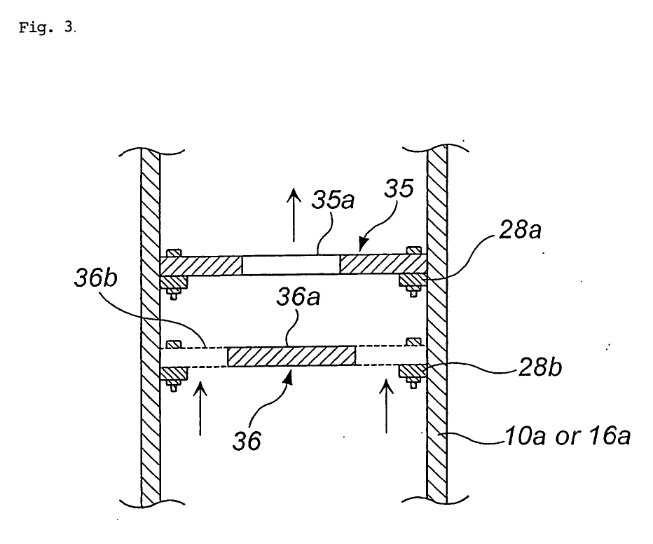

A partition means 25 which allows ventilation is provided between the thermally treating tower 10 and the exhaust gas tube 16. The partition means 25 is mounted removably at a flange portion (refer to FIG. 2 and FIG. 3) provided at an inner wall surface 10a of the thermally treating tower 10 or an inner wall surface 16a of the exhaust gas tube 16 by using a bolt and a nut.

The partition means 25 can comprises a wire mesh having many holes, a punching metal, a metal grating (an iron grating or the like), or a member similar thereto. The size of the hole which the partition means 25 possesses is such a size that the partition means allows a gas to pass therethrough but it does not allow an inflator 30 and fragments produced when the inflator 30 is broken to pass.

The size of the hole is not limited particularly as long as it can solve the problems of the present invention. When the hole is circular, a diameter thereof is preferably 150 mm or less, preferably 100 mm or less, and further preferably 20 mm or less. When the shape of the hole is another shape such as a square or the like, the size of a side of the hole may be adjusted such that the hole has an opening area approximately equal to the case of the circular hole.

It is preferable that the material of the partition means 25 is selected in view of a durability to a temperature inside the thermally treating tower 10, strength capable of withstanding a collision of an inflator 30 for a long term and the like. For example, as the material, stainless steel, iron or the like can be used.

One partition means 25 may be disposed, or two or more partition means may be disposed in a combination. When two or more partition means are combined, they may be disposed with an interval therebetween.

In the present invention, as shown in FIG. 1, a partition means 13 identical to the partition means 25 can also be mounted removably to the combustion furnace 14. A mounting position of the partition means 25 in the combustion furnace 14 may be between the combustion furnace 14 and the interior of the thermally treating tower 10, for example, an opening portion of a heating gas outlet duct 14a of the combustion furnace 14 as shown in FIG. 1, inside the heating gas outlet duct 14a of the combustion furnace 14 or the like.

In FIG. 2, a flat plate-like partition means 25 having vents 27 is mounted removably, by bolts 31 and nuts 32, at an outer peripheral edge portion of the partition means 25 and an inner peripheral edge portion of a flange portion 28 provided at an inner wall surface 10a of the thermally treating tower 10 or an inner wall surface 16a of the exhaust gas tube 16. The flange portion 28 and the partition means 25 may have such shapes that connection can be made at only respective connecting portions. For example-, there may be a notch in a portion of one or both of the inner peripheral edge portion of the flange portion 28 and the outer peripheral edge portion of the partition means 25. The arrows in FIG. 2 show flow of an exhaust gas.

By providing the flange portion 28 and mounting the partition means 25 using the bolts 31 and the like in this manner, a strength of the partition means 25 against a collision of the inflator 30 can be increased and a replacement work for the partition means 25 is also made easy. In particular, when the partition means 25 is mounted on the lower side (downstream of an exhaust gas) of the flange portion 28, the strength can further be increased.

FIG. 3 shows a schematic partial sectional view of two partition means arranged with an interval therebetween. In an embodiment shown in FIG. 3, passing of an inflator 20 and fragments produced when the inflator 20 is broken is blocked by a combination of an annular partition means 35 arranged at the upstream side of an exhaust gas and a flat plate-like partition means 36 arranged at the downstream side thereof. The arrows shown in FIG. 3 show flow of an exhaust gas.

The annular partition means 35 has a vent 35a at a central portion, and it is mounted removably at the flange portion 28a provided on the inner wall surface 10a of the thermally treating tower 10 or the inner wall surface 16a of the exhaust gas tube 16 and at the peripheral edge portion of the annular partition means 35 by bolts and nuts.

The flat plate-like partition means 36 comprises a central flat plate portion 36a larger than the area of a vent 35a, and plural (for example, four) supporting means 36b (which are shown with the broken lines in order to clarify that they allow ventilation in FIG. 3) formed at equal intervals around the central flat plate portion 36a and extending outwardly.

The flat plate-like partition means 35 is mounted removably at end portions of the four supporting means 36b and the flange portion 28b such that the central flat plate portion 36a and the gas vent 35a are exactly opposite to each other.

Incidentally, both the annular partition means 35 and the flat plate-like partition means 36 may be mounted on the inner wall surface 10a of the thermally treating tower 10 or the inner wall surface 16a of the exhaust gas tube 16, and such a constitution may be employed that, while the annular partition means 35 is mounted to the inner wall surface 16a of the exhaust gas tube 16, the flat plate-like partition means 36 is mounted to the inner wall surface 10 of the thermally treating and activating tower 10.

By combining two partition means 35 and 36 in this manner, since an impact generated when a jumped inflator 30 or fragments thereof collide against these partition means can be distributed to the two partition means 35 and 36, a durability can be increased as compared with a case of only one partition means. For this reason, a life until replacement of partition means can be prolonged.

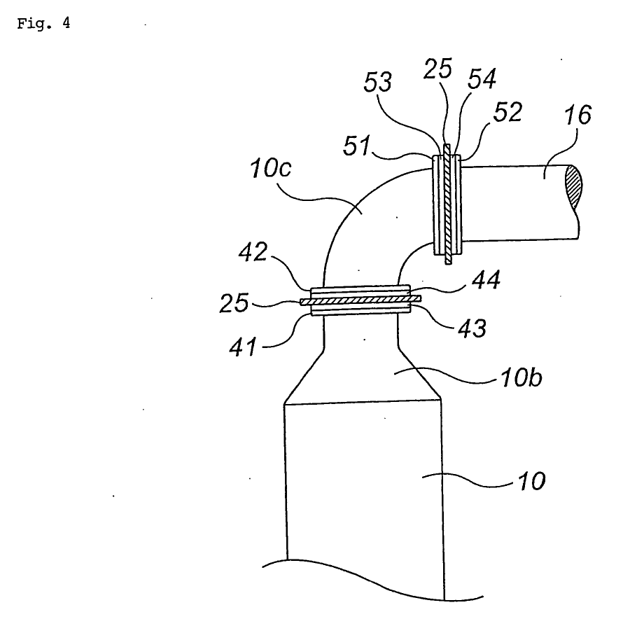

Next, another mounting method of the partition means will be explained with reference to FIG. 4. FIG. 4 is an appearance view for explaining the another mounting method of the partition means. In an embodiment shown in FIG. 4, the thermally treating tower 10 and the exhaust gas tube 16 are coupled to each other via an outlet duct 10b and an elbow duct 10c. The outlet duct 10b and the elbow duct 10c serve as a coupling tube between the thermally treating tower 10 and the exhaust gas tube 16. Incidentally, the outlet duct 10b or the outlet duct 10b and the elbow duct 10c may be integrated with the thermally treating tower 10 to form the thermally treating tower 10 as a whole. Alternatively, the elbow duct 10c or the elbow duct 10c and the outlet duct 10 may be integrated with the exhaust gas tube 16 to form the exhaust gas tube 16 as a whole.

A partition means 25 is arranged between the outlet duct 10b and the elbow duct 10c. The partition means 25 is sandwiched between a flange portion 41 of the outlet duct 10b and a flange portion 42 of the elbow duct 10c via two packing sheets 43 and 44, and in this state, the partition means 25 is mounted removably at the flange portion 41, an outer peripheral edge portion of the partition means 25 and the flange portion 42 by using bolts and nuts.

Another partition means 25 is arranged between the elbow duct 10c and the exhaust gas tube 16. The partition means 25 is sandwiched between a flange portion 51 of the elbow duct 10c and a flange portion 52 of the exhaust gas tube 16 via two packing sheets 53 and 54, and in this state, the partition means is mounted removably at the flange portion 51, an outer peripheral edge portion of the partition means 25 and the flange portion 52 by using bolts and nuts.

The mounting method shown in FIG. 4 is also made easy in a forming work of a flange portion and is made easy in a mounting work of a partition means, as compared with the methods shown in FIG. 2 and FIG. 3. In addition, regarding the performance itself functioning as a partition means, the mounting method shown in FIG. 4 can secure a performance equal to that in the mounting methods shown in FIG. 2 and FIG. 3. Further, in the embodiments shown in FIG. 2 and FIG. 3, there might be a possibility that the inflator collides against the flange portion 28 and the flange portion 28 is damaged, but in the embodiment shown in FIG. 4, there might be no possibility that flange portion is damaged.

Next, an operation of the inflator heating treatment equipment will be explained with reference to FIG. 1 and FIG. 2. The interior of the thermally treating tower 10 is preliminarily maintained at a high temperature by the burner 14. It is desirable that the temperature at this time is an ignition temperature of a gas generating-treating housed in the inflator 30.

When a required number of inflators 30 are charged from the inflator charging port 12, gas generating materials inside the inflators 30 are ignited and burnt to generate a combustion gas. At this time, the inflators 30 may jump up due to pressures (propelling forces) produced by combustion of the gas generating materials to cause such an event that they collide against an inner wall surface of the thermally treating tower 10 to rebound in the direction of the exhaust gas tube 16 or jump inside the combustion furnace 14. Further, it is expected that the housings of the inflators 30 are broken due to pressures produced at combustion times of the gas generating materials or pressures generated when the inflators 30 collide against an inner wall of the thermally treating tower 10, and that fragments thereof jumps in the direction of the exhaust tube 16 or the combustion furnace 14.

Even in such a case, however, since the partition means 25 and 13 are provided, the inflators 30 or fragments thereof are prevented from causing such an event that they jump into the exhaust gas tube 16 and the combustion furnace 14 (or the gas outlet duct 14a) to damage the same or close the gas flow passage.

The combustion gas passes through the vents 27 of the partition means 25 from the inside of the thermally treating tower 10 to be exhausted to the exhaust gas tube 16, and after it is washed and cooled with water spraying by the cooling shower 19 inside the cooling tower 17, it is discharged from the gas discharging tube 26 to the atmosphere via the cooling tower tank 18.

1. An inflator thermal treatment equipment for treating inflators for an air bag at a high temperature, comprising at least:
a thermally treating tower, and an exhaust gas tube for exhausting a gas generated inside the thermally treating tower, wherein a partition means which allows ventilation is provided between the thermally treating tower and the exhaust gas tube.

2. An inflator heating treatment equipment according to claim 1, wherein the partition means which allows ventilation is constituted to allow a gas to pass through but not to allow an inflator and fragments produced when the inflator is broken to pass through.

3. An inflator heating treatment equipment according to claim 1 or 2, wherein the partition means which allows ventilation is a wire mesh, a punching metal or a metal grating.

4. An inflator heating treatment equipment according to claim 1, wherein at least two partition means which allow ventilation are disposed with an interval therebetween.

5. An inflator thermal treatment equipment according to claim 4, wherein, when at least two partition means which allow ventilation are disposed, passing of the inflator and the fragments produced when the inflator is broken is blocked by a combination of two partition means.

6. An inflator thermal treatment equipment according to claim 5, wherein the combination of two partition means is a combination of an annular partition means disposed at the upstream side of an exhaust gas and a flat plate-like partition means disposed at the downstream side thereof.

7. An inflator heating treatment equipment according to claim 1 or 2, wherein the partition means which allows ventilation is mounted removably inside the exhaust gas tube, inside the thermally treating tower or inside a coupling tube therebetween.

8. An inflator thermal treatment equipment according to claim 1 or 2, wherein one or two or more partition means which allows ventilation are mounted removably at a position in the vicinity of the thermally treating tower inside the exhaust gas tube or a coupling tube between the exhaust gas tube and the thermally treating tower.

9. An inflator thermal treatment equipment according to claim 1 or 2, wherein the partition means which allows ventilation is mounted removably at a flange portion provided on an inner wall surface or an outer wall surface of the exhaust gas tube or a coupling tube between the exhaust gas tube and the thermally treating tower, or at a flange portion provided on an inner wall surface of the thermally treating tower.

10. An inflator thermal treatment equipment according to claim 1 or 2, wherein the thermally treating tower is attached with an inflator charging port and a combustion furnace, and the exhaust gas tube is provided with a means for cooling an exhaust gas.

11. An inflator thermal treatment equipment according to claim 10, wherein a partition means which allows ventilation and that allows a gas to pass through but does not allow an inflator and fragments produced when the inflator is broken to pass through is mounted removably between the combustion furnace attached to the thermally treating tower and the interior of the thermally treating tower.
